(19) United States
(12) Patent Application Publication
(10) Pub. No.: US 2012/0246072 A1
(43) Pub. Date: Sep. 27, 2012

(54) AUTHORIZING AN ADVANCE PAYMENT BASED ON PERFORMER DATA

(75) Inventors: Adriaan Ligtenberg, Kamakura (JP); David Marglin, San Francisco, CA (US); Ronald Tetteroo, London (GB); Roland Adrianus Ligtenberg, San Diego, CA (US)

(73) Assignee: Phaenom Limited, Jersey (GB)

(21) Appl. No.: 13/071,352

(22) Filed: Mar. 24, 2011

(51) Int. Cl. G06Q 40/00

(52) U.S. Cl. 705/44

(57) ABSTRACT

An authorization machine may be used by an authorizing entity to aggregate and analyze multiple reports that are pertinent to a performer of entertainment. The authorization machine may determine the performer's potential earnings for performing at an event to occur in the future. This determination may be based on one or more revenue-related reports that describe past transactions attributable at least in part to the performer. The authorization machine may then determine a likelihood that the performer will actually attain the potential earnings by performing at the event. This likelihood may be determined as a risk score based on one or more sentiment-related reports that describe the performer's popularity. Based on the potential earnings and the likelihood of attaining them, the authorization machine may authorize an advance payment corresponding to the performer.

### TECHNICAL FIELD

The subject matter disclosed herein generally relates to the processing of data. Specifically, the present disclosure addresses systems and methods of authorizing an advance payment based on performer data.

### BACKGROUND

A performer of entertainment may be featured to perform at an event, which may be scheduled to occur at a venue, from which consumers of entertainment (e.g., fans of the performer) may purchase tickets (e.g., directly or indirectly, online or physically) that enable the fans to experience the event. The event may be scheduled to occur on a single date or on multiple dates. The venue is a location suitable for presenting a performance by the performer, and the venue may have a name, a size, a capacity, a reputation, a degree of prestige, or any suitable combination thereof. The event (e.g., a festival) may involve performances by other performers, and the venue may have multiple locations (e.g., stages) within itself suitable for presenting one or more performances.

As used herein, a “performer” is an entity capable of performing at least one act for entertainment purposes. Accordingly, a performer may include any number of individual members. For example, a performer may be a soloist or an ensemble (e.g., group, troupe, team, squad, band, duo, trio, quartet, quintet, or choir). A performer may include a musician, a vocalist, a dancer, an actor, an athlete, a poet, a minister, a celebrity, a lecturer, a speaker, a coach, teacher, a politician, a comedian, a juggler, a magician, an acrobat, a daredevil, an animal, a clown, or any suitable combination thereof.

### BRIEF DESCRIPTION OF THE DRAWINGS

Some embodiments are illustrated by way of example and not limitation in the figures of the accompanying drawings.

FIG. 1 is a conceptual diagram illustrating influences that consumers of entertainment have on a performer, according to some example embodiments.

FIG. 2 is an information flow diagram illustrating generation and aggregation of reports pertinent to the performer from multiple report sources, according to some example embodiments.

FIG. 3 is an information flow diagram illustrating aggregation of reports from multiple server machines among the report sources, according to some example embodiments.

FIG. 4 is a network diagram illustrating a network environment suitable for authorizing an advance payment based on reports pertinent to a performer, according to some example embodiments.

FIG. 5 is a block diagram illustrating components of an authorization machine and contents of a database, according to some example embodiments.

FIG. 6 is a flowchart illustrating events in a workflow that involves authorizing an advance payment based on performer data, according to some example embodiments.

FIG. 7-8 are flowcharts illustrating operations in a method of authorizing an advance payment based on reports pertinent to a performer, according to some example embodiments.

FIG. 9 is a conceptual diagram illustrating examples of revenue-related reports pertinent to a performer, according to some example embodiments.

FIG. 10 is a conceptual diagram illustrating examples of sentiment-related reports pertinent to a performer, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

Example methods and systems are directed to authorizing an advance payment based on performer data (e.g., reports pertinent to a performer). Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

For performing at an event, a performer may expect to be paid a certain amount of money. This amount of money may be influenced by various factors, including, for example the popularity of the performer, the number of consumers (e.g., fans) that purchase tickets to the event, and the prices of the tickets sold for the event. Prior to the event, a small advance payment (e.g., an event fee) may be paid by the performer to arrange the event. In many cases, the event fee is only a small part of the total proceeds from ticket sales for the event, and there may be a significant delay between the ticket sales and the certain amount of money being paid to the performer from the total proceeds.

An authorizing entity (e.g., a business), using one or more of the example systems and methodologies described herein, may aggregate and analyze reports pertinent to a performer of entertainment. One or more of the methods and systems described herein may populate and access a database to generate various reports and determine various parameters relating to the performer. The reports may be repeatedly aggregated and analyzed over time from various report sources to determine trends as the performer data changes. Using one or more of the methods and systems described herein, the authorizing entity may fund an event to feature the performer by authorizing an advance payment corresponding to (e.g., paid to, or paid on behalf of) the performer. The advance payment may be paid to a venue for the event by a financial entity in cooperation with the authorizing entity. Monetary proceeds from the event may then be used by the venue to repay the advance payment (e.g., minus a fee charged by the venue). Additional monetary proceeds from the event may also be paid to the authorizing entity by the venue. The authorizing entity may then initiate payments to the performer from the repaid advance payment, the additional proceeds received, or a suitable combination thereof (e.g., minus a fee charged by the authorizing entity). Payments to or from the authorizing entity may be handled by the financial entity in cooperation with the authorizing entity.

An authorization machine may be used by the authorizing entity to aggregate and analyze the reports. In particular, the authorization machine may initiate a network crawling operation (e.g., by a network crawler application) to retrieve the reports from multiple server machines functioning as report sources. In some example embodiments, the authorization machine receives activity data from one or more fans of the performer (e.g., via an application executing on the fans' mobile devices), and the authorization machine generates one or more reports based on the activity data. For example, the activity data may indicate that a particular fan has expressed a particular sentiment (e.g., favorable or unfavorable) about the performer. As another example, the activity data may indicate that the particular fan has engaged in a transaction (e.g., a purchase of merchandise) at least partially attributable to the performer. The resulting aggregate of reports may be stored in a database for analysis by the authorization machine.

In analyzing the aggregate of reports, the authorization machine may determine the performer's potential earnings for performing at an event to occur in the future. This determination may be based on one or more revenue-related reports that describe past transactions attributable at least in part to the performer. The authorization machine may then determine a likelihood (e.g., probability) that the performer will actually attain the potential earnings by performing at the event. This likelihood may be determined as a risk score based on one or more sentiment-related reports that describe the performer's popularity (e.g., among fans of the performer, consumers of entertainment, or the general public). The authorizing machine may determine the risk score by applying various weights to the sentiment-related reports. These weights may be generated by a machine, by a human (e.g., an employee of the authorizing entity), or any suitable combination thereof, and the weights may be represented as a data structure (e.g., a correlates matrix) stored in the database.

Based on the potential earnings and the likelihood of attaining them, the authorization machine may authorize an advance payment corresponding to (e.g., paid to, or paid on behalf of) the performer. The advance payment may be an amount of money different from the potential earnings of the performer. The authorization machine may then communicate the authorization of the advance payment to a financial entity (e.g., a bank or lender) that is configured to provide the advance payment to the performer or to the venue for the event on behalf of the performer. According to some example embodiments, the authorization machine communicates the authorization directly to the performer or to the venue for the event. Further details, operations, and variants of the authorization machine are described below.

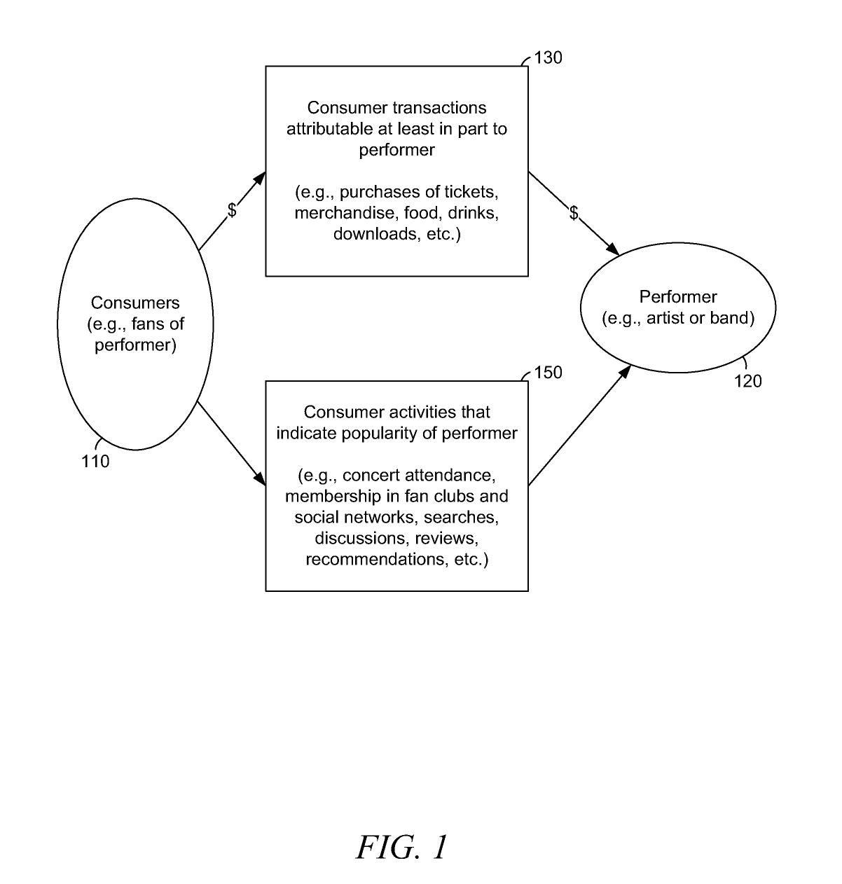

FIG. 1 is a conceptual diagram illustrating influences that consumers 110 of entertainment have on a performer 120, according to some example embodiments. The consumers 110 may include fans of the performer (e.g., persons who self identify as fans of the performer), as well as members of the general public. For example the consumers 110 may include those who contribute (e.g., directly or indirectly) to revenue that is at least partially attributable to the performer, those who express one or more sentiments (e.g., favorable or unfavorable) regarding the performer, or both. Accordingly, the consumers 110 may include critics, reviewers, broadcasters, distributors, celebrities, other performers, fans of other performers, or any suitable combination thereof.

As shown by the arrows marked with dollar signs “$” in FIG. 1, the consumers 110 may participate in consumer transactions 130 that are attributable at least in part to the performer. For example, one or more the consumers 110 may purchase an item related to an event featuring the performer (e.g., concert tickets, merchandise, food, drinks, or souvenirs). As another example, one or more of the consumers 110 may purchase media by the performer, such as a piece of music, video, lyrics, or any suitable combination thereof. The media may be purchased in the form of one or more compact discs (CDs), digital versatile disks (DVDs), or digital downloads. At least a portion of such purchases (e.g., fees for royalties or licenses) contributes to the revenue of the performer. Accordingly, the consumer transactions 130 may be analyzed to determine current earnings, historical earnings, or both, that are influenced by the performer. An authorization machine may perform this analysis (e.g., once or repeatedly over time) to determine the performer's potential earnings, as well as an earnings trend for the performer.

As shown by the unmarked arrows in FIG. 1, the consumers 110 may participate in consumer activities 150 that indicate the popularity of the performer. For example, one or more of the consumers 110 may attend an event featuring the performer (e.g., a concert, a book signing, a party, or a public appearance). As another example, one or more of the consumers 110 may become a member of a fan club of the performer or join a social network of the performer. As a further example, one or more of the consumers 110 may use a search engine by submitting a query that references the performer or a work of the performer (e.g., a piece of music by the performer). Further examples of the consumer activities 150 include contributing to discussions (e.g., online), participating in polls (e.g., online), writing reviews, making recommendations, or any suitable combination thereof. The consumer activities 150 express sentiments held by the consumers 110 regarding the performer and, accordingly, may be analyzed to determine a level of popularity for the performer among the consumers 110. An authorization machine may perform this analysis (e.g., once or repeatedly over time) to determine the likelihood that the performer will attain the potential earnings determined from the consumer transactions 130, as well as a risk trend that the performer will fail to attain the potential earnings.

For purposes of explaining the example embodiments described herein, the performer 120 is discussed and described as a musical artist or a band of musicians. As noted above, however, the performer 120 may be any entity capable of performing an act for entertainment purposes.

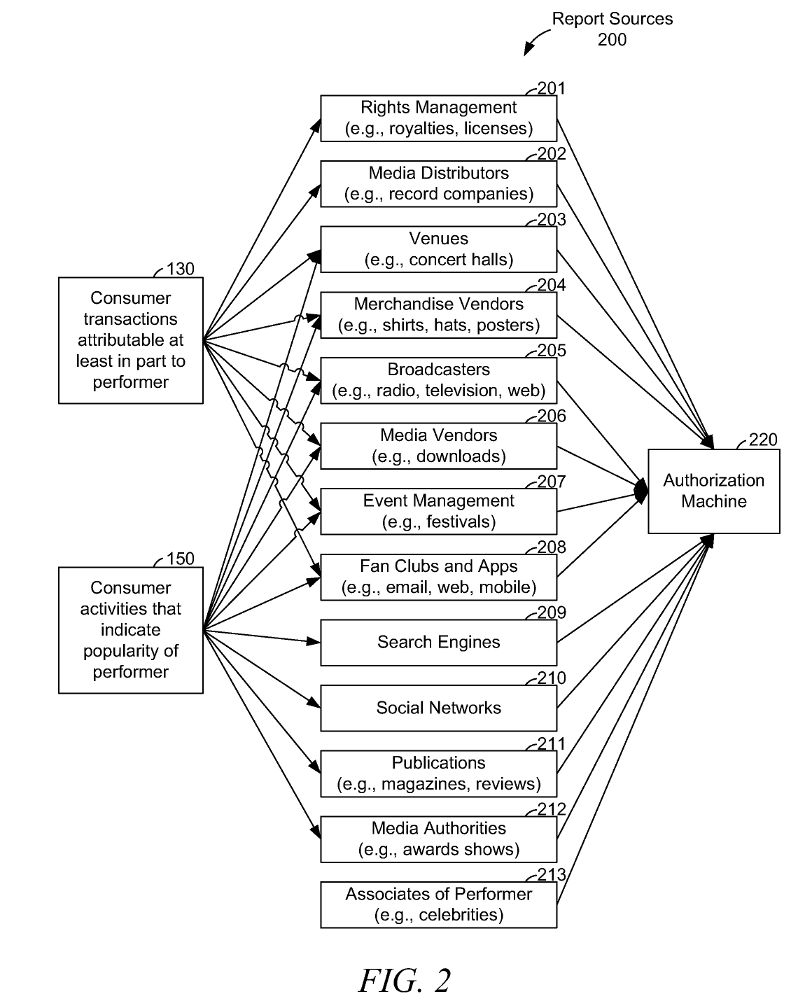

FIG. 2 is an information flow diagram illustrating generation and aggregation of reports pertinent to the performer 120 from multiple report sources 200, according some example embodiments. The report sources 200 are shown as including various example categories 201-213 of sources for information pertinent to the performer 120.

The category 201 includes entities (e.g., individuals, organizations, or businesses) involved with rights management (e.g., charging fees for royalties or licenses) with respect to the performer 120, works by the performer 120, or both. The category 202 includes entities involved with distributing media featuring the performer 120 (e.g., record companies). The category 203 includes entities that own or operate venues at which events (e.g., concerts) featuring the performer are held. The category 204 includes entities involved in selling merchandise (e.g., t-shirts, hats, or posters) that features the performer 120. The category 205 includes broadcasters (e.g., radio, television, or Internet) of media that features the performer 120 (e.g., a live concert, a recorded concert, news, or a piece of music). The category 206 includes entities that sell media featuring the performer 120 (e.g., CDs or digital downloads). The category 207 includes entities that manage an event featuring the performer 120 (e.g., organizers of the multi-day music festival).

The category 208 includes entities operating fan clubs of the performer 120 or distributing consumer software pertinent to the performer 120 (e.g., as well as pertinent to other performers). The category 209 includes entities that operate or administer search engines (e.g., Internet search engines or database search engines) that may return search results referencing the performer 120. The category 210 includes entities that operate or administer social networks (e.g., a social networking service) pertinent to the performer 120 (e.g., a social network for the performer 120, for a member of the performer 120, or for a group of performers of which the performer 120 is a part). The category 211 includes entities that publish a publication (e.g., a magazine, a review, or an article), in print or online, that mentions the performer 120. The category 212 includes entities that function as media authorities within an industry sector pertinent to the performer 120 (e.g., organizers of an awards show). The category 213 includes entities (e.g., celebrities or other performers) that associate with the performer 120 and that may be well-known or popular among the consumers 110 or the general public.

As shown in FIG. 2, information from the consumer transactions 130 may flow to one or more of the entities in the categories 201-208, and that information may further flow to an authorization machine 220 (e.g., operated by the authorizing entity for an advance payment corresponding to the performer 120). In a similar fashion, information from the consumer activities 150 may flow to one or more of the entities in the categories 203-212, and that information may further flow to the authorization machine 220. Additionally, one or more entities in the category 213, for example, may receive no information from the consumer transactions 130 or the consumer activities 150, and yet still provide information to the authorization machine 220. An entity in any of the categories 201-213 may receive additional information from sources of information not shown in FIG. 2 (e.g., consumer transactions attributable to an associate of the performer 120 or consumer activities indicating the popularity of an associate of the performer 120) and provide that information to the authorization machine 220.

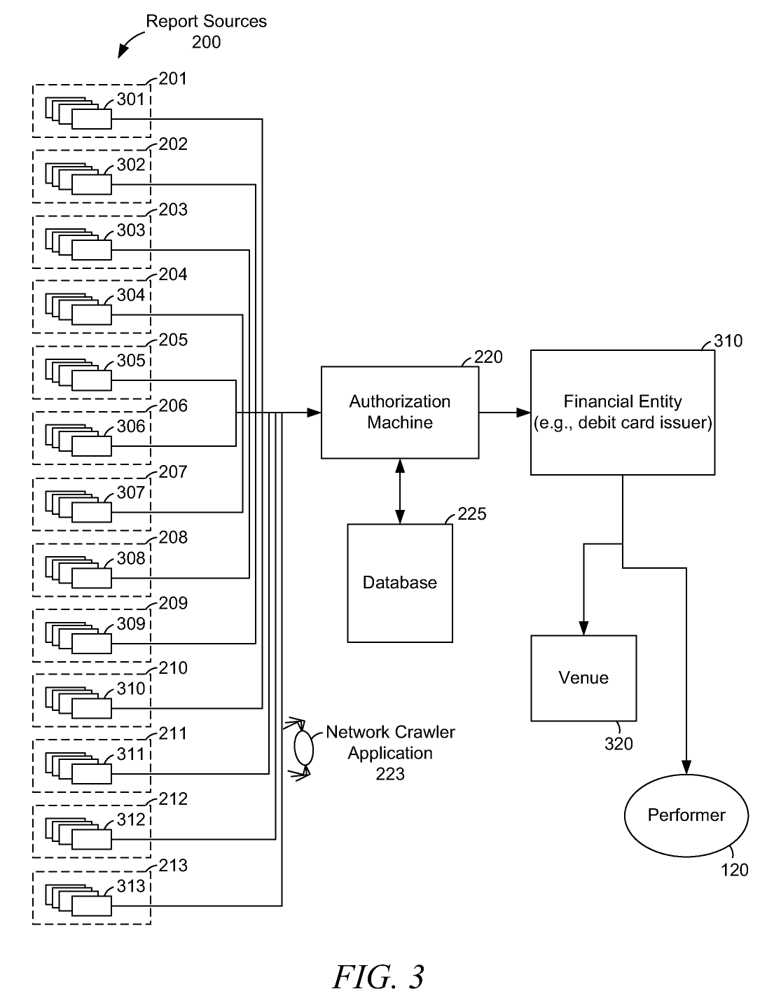

FIG. 3 is an information flow diagram illustrating aggregation of reports from multiple server machines 301-313 among the report sources 200, according to some example embodiments. Each of the categories 201-213 of sources includes one or more server machines (e.g., server machine 301), which is communicatively coupled to the authorization machine 220. Any one or more of the server machines (e.g., server machine 301) may be a device (e.g., a mobile device) of a user (e.g., a consumer or a fan). For example, the device may be configured by software (e.g., a mobile application) to function as a server with respect to the authorization machine 220.

Any one or more of the server machines (e.g., server machine 301) may communicate a report pertinent to the performer 120 to the authorization machine 220. Communication of the report may occur, for example, in response to a request sent by the authorization machine 220; in response to communication of one or more other reports by one or more other server machines; in response to arrival of new information pertinent to the performer 120; or based on a periodic cycle (e.g., daily, weekly, or monthly updates). In some example embodiments, the authorization machine 220 initiates a network crawling operation that is configured to access one or more server machines and aggregate reports available thereon. The network crawling operation may be performed using a network crawler 223, which may be implemented by the authorization machine 220.

The authorization machine 220 aggregates reports pertinent to the performer 120 and stores them as an aggregate of reports in the database 225, which is communicatively coupled to the authorization machine 220. The database 225 may store the reports indefinitely (e.g., for trend analysis). In the flow of information shown in FIG. 3, the authorization machine 220 accesses the reports from the database 225, performs an analysis of the reports, and communicates an authorization of an advance payment corresponding to (e.g., paid to, or paid on behalf of) the performer 120. The authorization is communicated to a financial entity 310 that is in cooperation with the authorizing entity. The financial entity 310 is an entity able to provide money, credit, or both, and accordingly may be, for example, a bank, a lender, a debit card issuer, or any suitable combination thereof.

As shown in FIG. 3, the financial entity 310 communicates the advance payment (e.g., a notification of the advance payment) to the performer 120 (e.g., to a bank account or residential address of the performer 120), a venue 320 for an event that will feature the performer 120, or both. In some example embodiments, the financial entity 310 provides financial services to the performer 120 (e.g., in addition to providing financial services to the authorizing entity), and the financial entity 310 may communicate a notification of the advance payment via email, text message, instant message, certified letter, or any suitable combination thereof, to the performer 120. In some example embodiments, the authorizing entity includes the financial entity 310 (e.g., controls the financial entity 310), and the authorization machine 220 may be combined with the financial entity 310 into a single machine or system. Accordingly, this information flow may facilitate a funding of an event (e.g., a future event) featuring the performer 120.

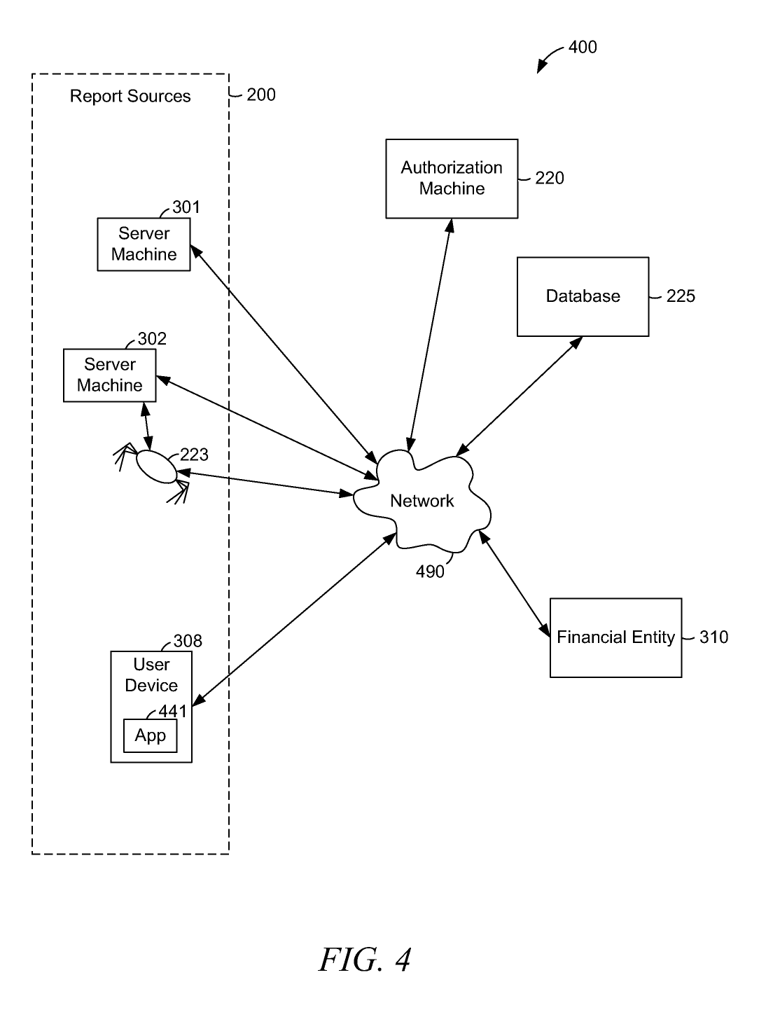

FIG. 4 is a network diagram illustrating a network environment 400 suitable for authorizing an advance payment based on reports pertinent to the performer 120, according to some example embodiments. The network environment 400 includes the report sources 200, the authorization machine 220, the database 225, and the financial entity 310, all communicatively coupled to each other via a network 490.

The report sources 200 are shown as including the server machines 301, 302, and 308. The server machine 308 is labeled “User Device” to illustrate that a server machine may be a device of the user. As shown, the server machine 308 is configured by a software application 441, which is labeled “App” in FIG. 4. The software application 441 configures the server machine 308 to communicate activity data (e.g., of a user with respect to the performer 120), one or more reports, or any suitable combination thereof, to the authorization machine 220.

The network crawler 223 is shown accessing the server machine 302 and communicating one or more reports using the network 490. The network crawler 223 may be a software application implemented by (e.g., executing on) the authorization machine 220, the database 225, or any suitable combination thereof. The network crawler 223 may be configured to perform a network crawling operation and access any one or more of the report sources 200.

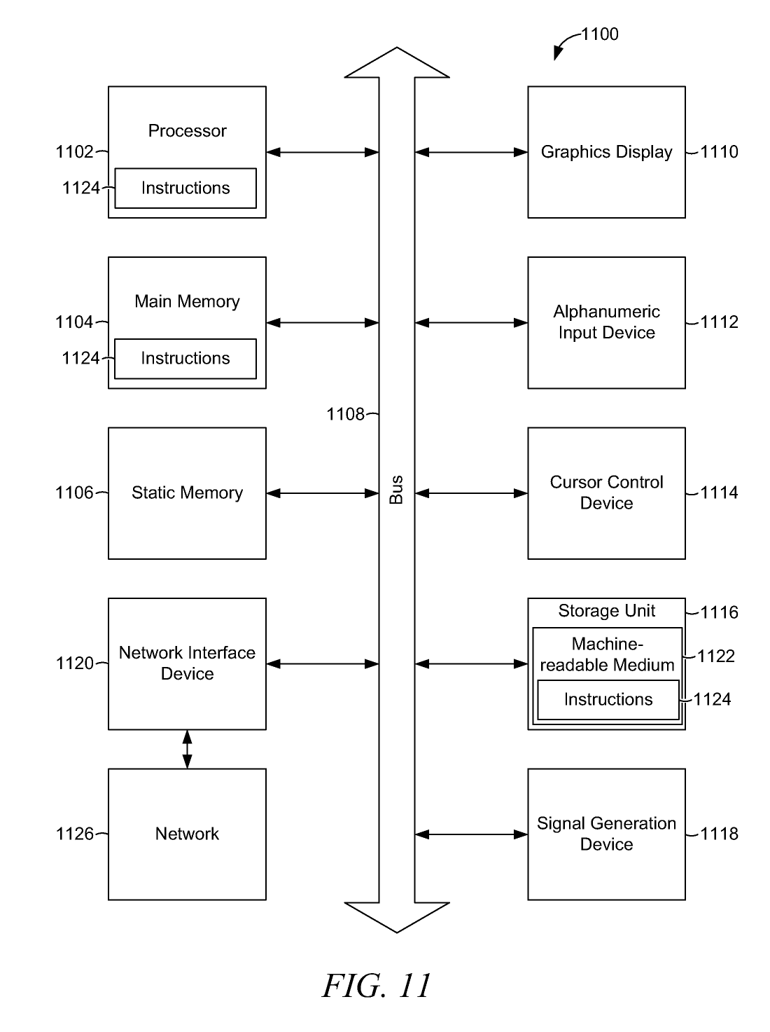

Any of the machines, databases, or devices shown in FIG. 4 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 11. As used herein, a “database” is a data storage resource and may store data structured as a text file, a table, a spreadsheet, a relational database, a triple store, or any suitable combination thereof. Moreover, any two or more of the machines illustrated in FIG. 4 may be combined into a single machine, and the functions described herein for any single machine may be subdivided among multiple machines.

The network 490 may be any network that enables communication between machines (e.g., authorization machine 220). Accordingly, the network 490 may be a wired network, a wireless network, or any suitable combination thereof. The network 490 may include one or more portions that constitute a private network, a public network (e.g., the Internet), or any suitable combination thereof.

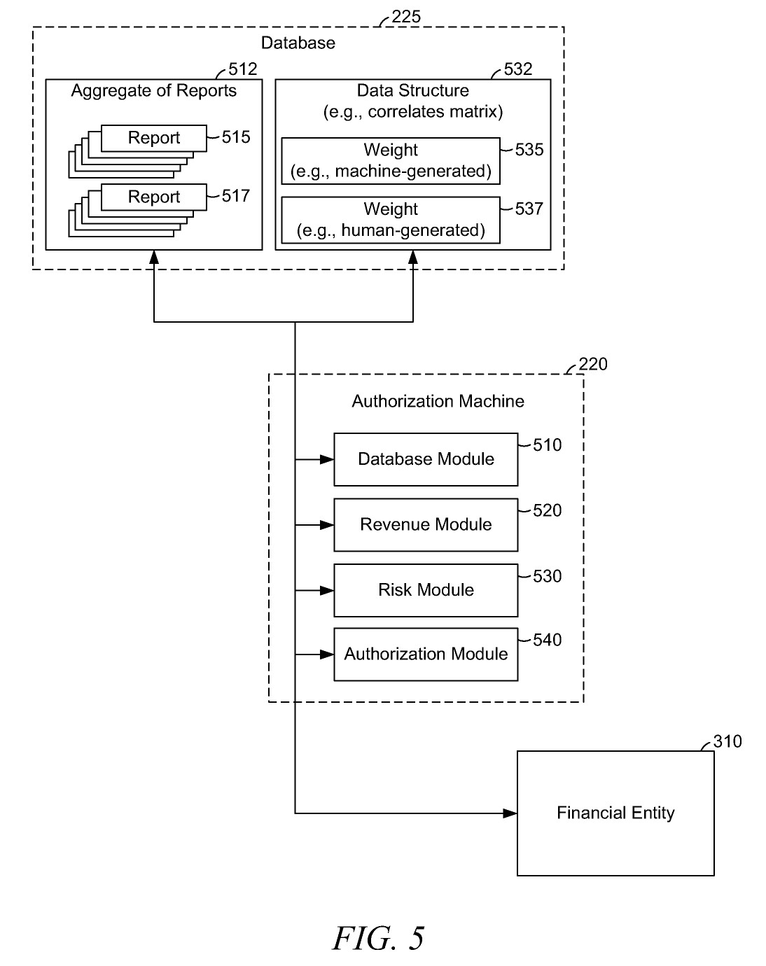

FIG. 5 is a block diagram illustrating components of the authorization machine 220 and contents of the database 225, according to some example embodiments. The authorization machine 220 includes a database module 510, a revenue module 520, a risk module 530, and an authorization module 540, all configured to communicate with each other (e.g., via a bus, shared memory, or a switch). Any one or more of these modules may be implemented using hardware (e.g., a processor of a machine) or a combination of hardware and software. Moreover, any two or more of these modules may be combined into a single module, and the functions described herein for a single module may be subdivided among multiple modules.

The database 225 stores an aggregate 512 of reports, which includes the aggregated reports pertinent to the performer 120. The aggregate 512 of reports includes multiple reports (e.g., report 515) that are related to revenue directly or indirectly attributable, at least in part, to the performer 120. These revenue-related reports are descriptive of one or more of the consumer transactions 130, which are attributable at least in part to the performer 120. The aggregate 512 of reports also includes multiple reports (e.g., report 517) that are related to sentiments expressed by at least some of the consumers 110 regarding the performer 120. The sentiment-related reports are descriptive of the popularity (e.g., a degree of popularity) of the performer 120, as indicated by one or more of the consumer activities 150.

The database 225 also stores data structure 532, which may include weights 535 and 537. One or more additional weights may be included in the data structure 532. Each of the weights 535 and 737 may be a numerical factor (e.g., a floating-point number between 0 and 1) that may be mathematically applied to adjust the influence of a report within the aggregate 512 of reports (e.g., multiplied to a default level of relative influence of the report). One or both of the weights 535 and 537 may be generated by a machine, and one or both of the weights 535 and 537 may be generated by human. In some example embodiments, the data structure 532 is a correlates matrix, and one or more of the weights 535 and 537 may be represented as numerical factors stored within the correlates matrix.

As shown in FIG. 5, the database module 510 is configured to access the aggregate 512 of reports, as well as any one or more reports (e.g., reports 515 and 517) contained in the aggregate 512 of reports.

The revenue module 520 is configured to determine an amount (e.g., first amount) of money that the performer 120 is able to earn. The revenue module 520 may perform this determination based on revenue-related reports (e.g., report 515) contained in the aggregate 512 of reports. Moreover, the revenue module 520 may access the data structure 532 and apply one or more weights (e.g., weights 535 and 537) to adjust the influence of one or more of the revenue-related reports.

The risk module 530 is configured to determine a likelihood (e.g., a probability) that the performer 120 will attain the amount of money determined by the revenue module 520. The likelihood may be expressed as a risk score representing a risk that the performer 120 will fail to attain the amount of money determined by the revenue module 520. The risk module 530 may perform this determination based on sentiment-related reports (e.g., report 517) contained in the aggregate 512 of reports. Moreover, the risk module 530 may access the data structure 532 and apply one or more weights (e.g., weights 535 and 537) to adjust the influence of one or more of the sentiment-related reports.

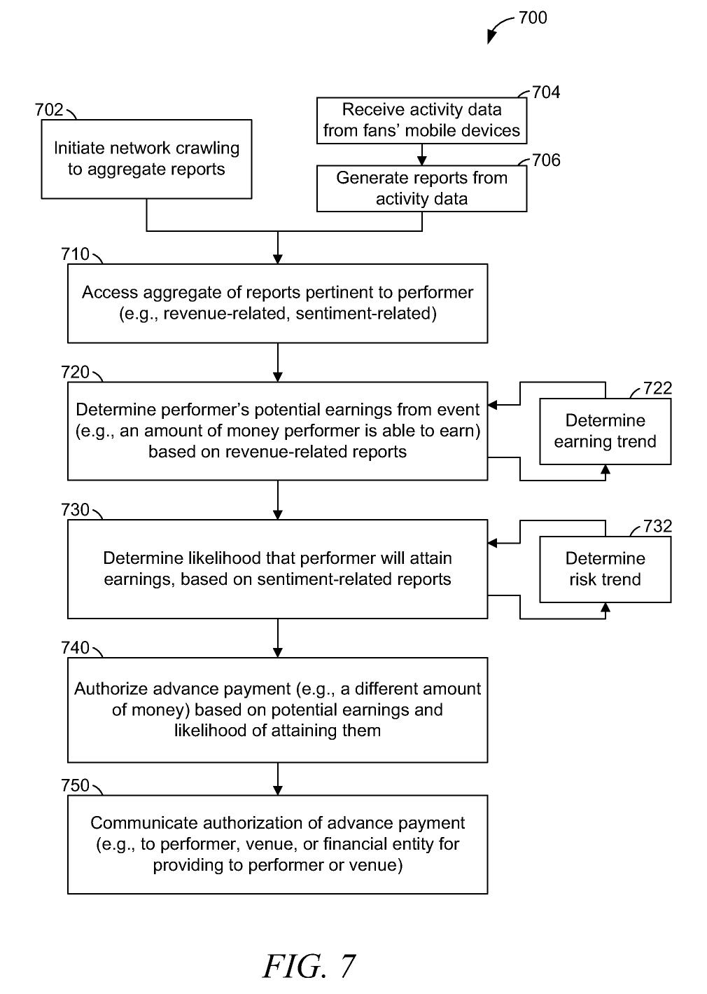

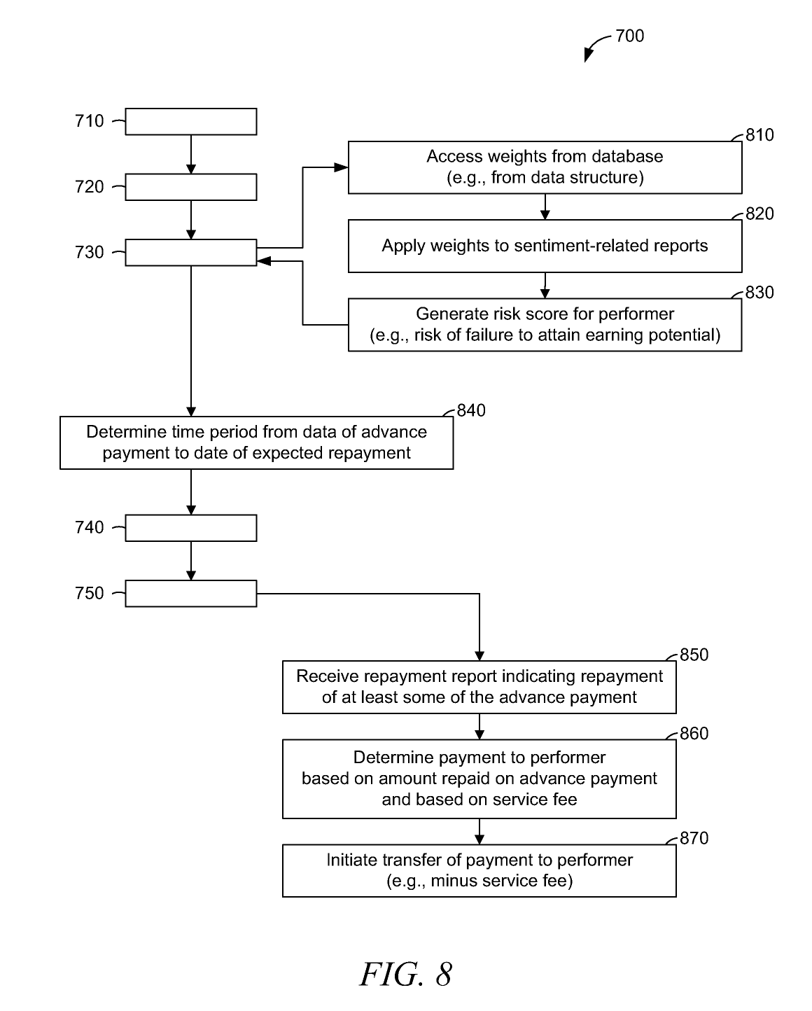

The authorization module 540 is configured to authorize another amount (e.g., a second amount) of money as an advance payment to be made corresponding to (e.g., paid to, or paid on behalf of) the performer 120. The authorization module 540 is further configured to communicate to the financial entity 310 and accordingly may communicate the authorization of the advance payment on behalf of the performer 120 to the financial entity 310. Further details, operations, and variants of the modules of the authorization machine 220 are discussed below with respect to FIG. 7-8.

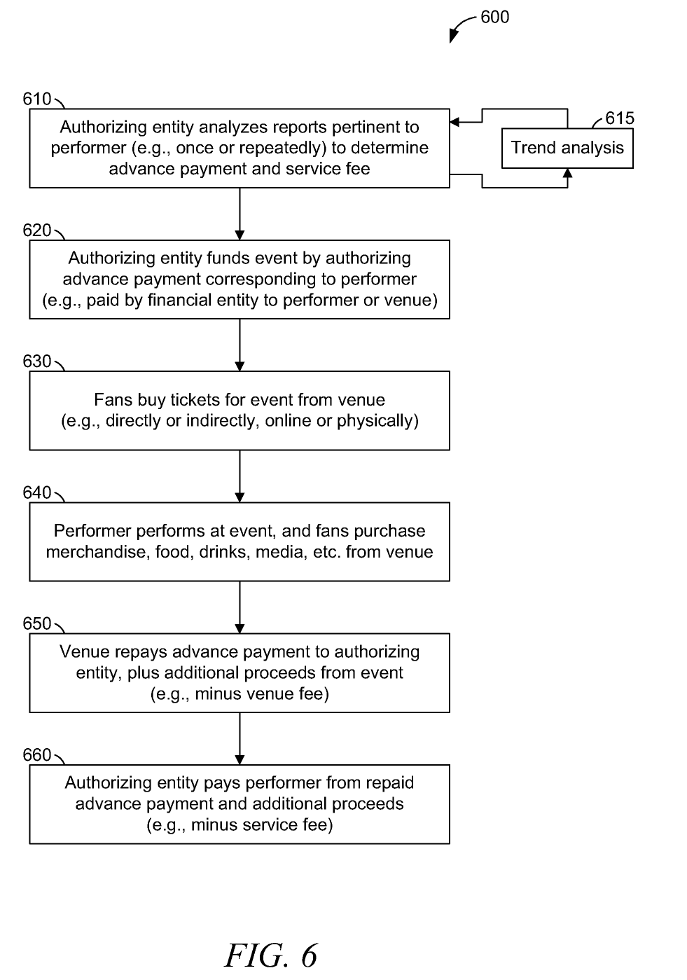

FIG. 6 is a flowchart illustrating events in a workflow 600 that involves authorizing an advance payment based on the aggregate 512 of reports, according to some example embodiments. The workflow 600 includes events 610-660 and may constitute all or part of a business method that may be implemented using the authorization machine 220.

In event 610, an authorizing entity (e.g., an individual, an organization, or a business) uses the authorizing machine 220 to analyze the aggregate 512 of reports and determine an amount of an advance payment to be made corresponding to (e.g., paid to, or paid on behalf of) the performer 120 featured at an upcoming event to be presented at a venue. The authorizing entity may also use the authorizing machine 220 to determine a service fee to be charged by the authorizing entity to the performer 120 for handling the advance payment. The service fee may be determined as a fixed amount, a percentage of proceeds from the event, or any suitable combination thereof.

In event 615, the authorizing entity uses the authorization machine 220 to repeat operation 610 and perform a trend analysis to determine a trend of the performer 120 (e.g., an earnings trend or a risk trend). Accordingly, events 610 and 615 may be repeated over time (e.g., routinely or in response to new or updated reports aggregated into the aggregate 512 of reports), and the trend may be updated with each repetition.

In event 620, the authorizing entity funds the event by authorizing the advance payment corresponding to (e.g., paid to, or paid on behalf of) the performer 120. The advance payment may be requested by the authorizing entity to be paid by the financial entity 310 to the performer 120, the venue for the event, or any suitable combination thereof. In some example embodiments, the authorizing entity pays the performer 120, the venue, or both, without using the financial entity 310.

In event 630, consumers (e.g., fans of the performer 120) purchase tickets for the event from the venue. Accordingly, the venue begins accumulating money with which to repay the advance payment. Depending on the number and price of the tickets sold to the consumers, as well as the amount of the advance payment, the venue may complete accumulation of money with which to repay the advance payment and began accumulating additional proceeds from the event.

In event 640, the event occurs. The performer 120 performs at the event, and attendees of the event (e.g., fans of the performer 120) make additional purchases (e.g., of merchandise, food, drinks, or media) from the venue or from vendors affiliated with the venue. Accordingly, the venue may further accumulate revenue from the event.

In event 650, the venue repays the advance payment to the authorizing entity. The venue may also pay additional proceeds from the event, and the venue may keep a fee for use of the venue for the event (e.g., a venue fee).

In event 660, the authorizing entity pays the performer 120 from monies provided by the venue. The authorizing entity may use the authorizing machine 220 to initiate a transfer of an amount (e.g., third amount) of money as a payment to the performer 120. The authorizing entity may keep a fee for handling the advance payment and for processing the repayment of the advance payment (e.g., a service fee).

FIG. 7-8 are flowcharts illustrating operations in a method 700 of authorizing an advance payment based on the aggregate 512 of reports pertinent to the performer 120, according to some example embodiments. The method 700 includes operations 710, 720, 730, and 740. According to various example embodiments, the method 700 may include one or more of operations 702-706, 720, 732, 750, and 810-870. Operations of the method 700 may be performed by the authorization machine 220, using modules described above with respect to FIG. 5.

In operation 702, the database module 510 of the authorization machine 220 initiates a network crawling operation to access one or more server machines (e.g., server machine 301) and aggregate reports from one or more of the report sources 200. The reports may include revenue-related reports (e.g., report 515), sentiment-related reports (e.g., report 517), or any suitable combination thereof. The database module 510 may use the network crawler 223 to perform operation 702. The aggregated reports are stored by the database module 510 in the database 225 (e.g., within the aggregate 512 of reports). Moreover, operation 702 may include the database module 510 updating the database 225 (e.g., by updating the aggregate 512 of reports) to include one or more reports accessed by the network crawling operation (e.g., accessed by the network crawler 223).

In operation 704, the database module 510 receives activity data from one or more devices (e.g., server machine 308) among the report sources 200, where the one or more devices are configured (e.g., by the software application 441) to interact with one or more fans of the performer 120. The activity data indicates a level of interest in the performer 120 expressed by the one or more fans while interacting with the one or more devices. For example, the activity data may indicate an amount of time spent by a fan experiencing a work of the performer 120, a number of activities performed by the fan in interacting with a website of the performer 120, a number of times the fan references the performer 120 in queries to the search engine, or any suitable combination thereof. The received activity data may be stored by the database module 510 in the database 225.

In operation 706, the database module 510 generates one or more reports (e.g., sentiment-related reports) based on the activity data received in operation 704. The generated reports may be stored by the database module 510 in the database 225 (e.g., within the aggregate 512 of reports). Accordingly, operation 706 may include the database module 510 updating the database 225 (e.g., by updating the aggregate 512 of reports) to include one or more of the generated reports.

In operation 710, the database module 510 of the authorization machine 220 accesses the aggregate 512 of reports. Accessing the aggregate 512 of reports may be performed by accessing the database 225. In some example embodiments, the aggregate 512 of reports is stored in a memory of the authorization machine 220, and operation 710 is performed by accessing the memory. For example, the database module 510 may load the aggregate 512 of reports into the memory and then read the aggregate 512 of reports from the memory.

In operation 720, the revenue module 520 determines a first amount of money that the performer 120 is able to earn (e.g., is expected to be able to earn). The first amount of money represents potential earnings of the performer 120 for performing at an event (e.g., a future event). The revenue module 520 may determine the first amount of money based on one or more revenue-related reports (e.g., report 515) within the aggregate 512 of reports, as accessed in operation 710.

In operation 722, the revenue module 520 determines an earning trend of the performer 120. The earning trend is determined based on repetitions of operation 720 over time. These repetitions may be periodic (e.g., routinely executed), executed in response to new or updated revenue-related reports (e.g., stored in the database 225), executed upon demand (e.g., by an employee of the authorizing entity), or any suitable combination thereof.

In operation 730, the risk module 530 of the authorization machine 220 determines a likelihood that the performer 120 will earn the first amount of money. The likelihood may be determined as a probability that the first amount of money will be earned by the performer 120 for performing at the event. The risk module 530 may determine the likelihood based on one or more sentiment-related reports (e.g., report 517) within the aggregate 512 of reports, as accessed in operation 710. In some example embodiments, the likelihood may be determined as a risk score indicating a risk that the performer 120 will fail to earn the first amount of money (e.g., by performing at the event).

In operation 732, the risk module 530 determines a risk trend of the performer 120. The risk trend is determined based on repetitions of operation 730 over time. These repetitions may be periodic (e.g., routinely executed), executed in response to new or updated revenue-related reports (e.g., stored in the database 225), executed upon demand (e.g., by an employee of the authorizing entity), or any suitable combination thereof.

In operation 740, the authorization module 540 of the authorization machine 220 authorizes a second amount of money as an advance payment corresponding to (e.g., paid to, or paid on behalf of) the performer 120. The authorizing of the second amount of money is based on the first amount of money (e.g., as determined in operation 720) and based on the likelihood that the performer 120 will earn the first amount of money (e.g., as determined in operation 730). The second amount of money may be the same as or different from the first amount of money. Moreover, the authorization module 540 may store information describing the second amount of money in the database 225 as an authorized amount of money corresponding to the performer 120.

In operation 750, the authorization module 540 communicates the second amount of money as the advance payment for the performer 120. For example, the authorization module 540 may communicate a message that indicates the second amount of money as being the advance payment correspond to the performer 120. The second amount of money (e.g., a message that indicates a second amount of money) may be communicated to the performer 120, the venue 320, the financial entity 310 (e.g., for providing to the performer 120 over the venue 320), or any suitable combination thereof The communication of the second amount of money may form all or part of an authorization of the advance payment.

As shown in FIG. 8, various example embodiments of the method 700 may include one or more of operations 810-870. Operations 810-830 may be included in operation 730 in which the risk module 530 of the authorization machine 220 determines the likelihood that the performer 120 will earn the first amount of money.

In operation 810, the risk module 530 accesses one or more weights (e.g., weights 535 and 537) stored in the data structure 532 (e.g., a correlates matrix) within the database 225. As noted above, one or more of the weights may be human-generated, machine-generated, or any suitable combination thereof. The risk module 530, the database 225, or both, however, may be implemented by computer hardware, according to various example embodiments.

In operation 820, the risk module 530 applies the one or more weights to one or more sentiment-related reports (e.g., report 517), as accessed in operation 710. For example, one of the sentiment-related reports may have a default level of influence, and one of the weights may be multiplied to that default level of influence to adjust the influence of that sentiment-related report in determining the likelihood.

In operation 830, the risk module 530 generates a risk score that indicates a risk (e.g., a degree of risk) that the performer 120 will fail to earn the first amount of money (e.g., as determined in operation 720). In performing operation 730, the risk module 530 may determine the likelihood based on the risk score. In some example embodiments, the likelihood is the risk score. In various example embodiments, the likelihood as a normalized expression of the risk score (e.g., normalized with respect to other performers in a similar category of performers). In certain example embodiments, operations 810 and 820 are included in operation 830.

Operation 840 may be performed by the authorization module 540 prior to performance of operation 740, in which the authorization module 540 authorizes the second amount of money as the advance payment corresponding to (e.g., paid to, or paid on behalf of) the performer 120. In operation 840, the authorization module 540 of the authorization machine 220 determines a time period from a date for communicating the second amount of money (e.g., the advance payment, as communicated in operation 750) until a further date of an expected repayment of at least some of the second amount of money. In other words, the authorization module 540 may determine a length of time between an anticipated or requested communication of the advance payment until an anticipated or requested repayment of that advance payment. In various example embodiments, the further date of the expected repayment is the date of the event featuring the performer 120. For example, if the performer 120 has requested immediate authorization of an advance payment for a rock concert scheduled to occur in one month, the authorization module 540 may determine the time period as one month.

In example embodiments that include operation 840, performance of operation 740 may be based on the time period determined in operation 840. Accordingly, the amount of the advance payment authorized in operation 740 may be influenced by the length of time before repayment is expected to begin.

One or more of operations 850-870 may be performed by the authorization module 540 after performance of operation 750. According to various example embodiments, one or more of operations 850-870 may be performed on or after the date of the event featuring the performer 120.

In operation 850, the authorization module 540 of the authorization machine 220 receives a repayment report (e.g., via email, text message, network crawler 223, or application software 441). The repayment report may be received from the financial entity 310, the venue 320, the performer 120, or any suitable combination thereof. The repayment report indicates a reception (e.g., by the financial entity 310 or the authorizing entity) of at least some of the second amount of money (e.g., as communicated in operation 750) in repayment of the advance payment corresponding to the performer 120.

In operation 860, the authorization module 540 determines a third amount of money that is to be paid to the performer 120 (e.g., from proceeds of the event featuring the performer 120). The third amount of money may be determined based on the amount of money indicated by the repayment report as being received in repayment of the advance payment. For example, the third amount of money may be equal to the second amount of money. In some example embodiments, the third amount of money is determined to be the second amount of money minus a service fee charged by the authorizing entity for handling the advance payment for the performer 120.

In performing operation 860, the authorization module 540 may determine a service fee (e.g., to be subtracted from the second amount of money in determining the third amount of money). According to various example embodiments, the service fee may be determined based on the first amount of money (e.g., as determined in operation 720), the likelihood that the performer 120 will earn the first amount (e.g., as determined in operation 730), the time period between the advance payment and its corresponding repayment (e.g., as determined in operation 840), or any suitable combination thereof. In other words, the service fee may be determined based on the potential earnings of the performer 120, the likelihood that the performer 120 will attain the potential earnings, the amount of time before the advance payment will be repaid, or any suitable combination thereof. In some example embodiments, the likelihood is expressed as the risk score generated in operation 830 or as a normalized expression of the risk score.

In operation 870, the authorization module 540 initiates a transfer of the third amount of money to the performer 120. For example, the authorization module 540 may communicate a request to the financial entity 310, where the request indicates that the financial entity 310 is authorized to transfer of the third amount of money to the performer 120. Operation 870 may include the authorization module 540 communicating a notification to the performer 120 that the transfer of the third amount of money has been initiated.

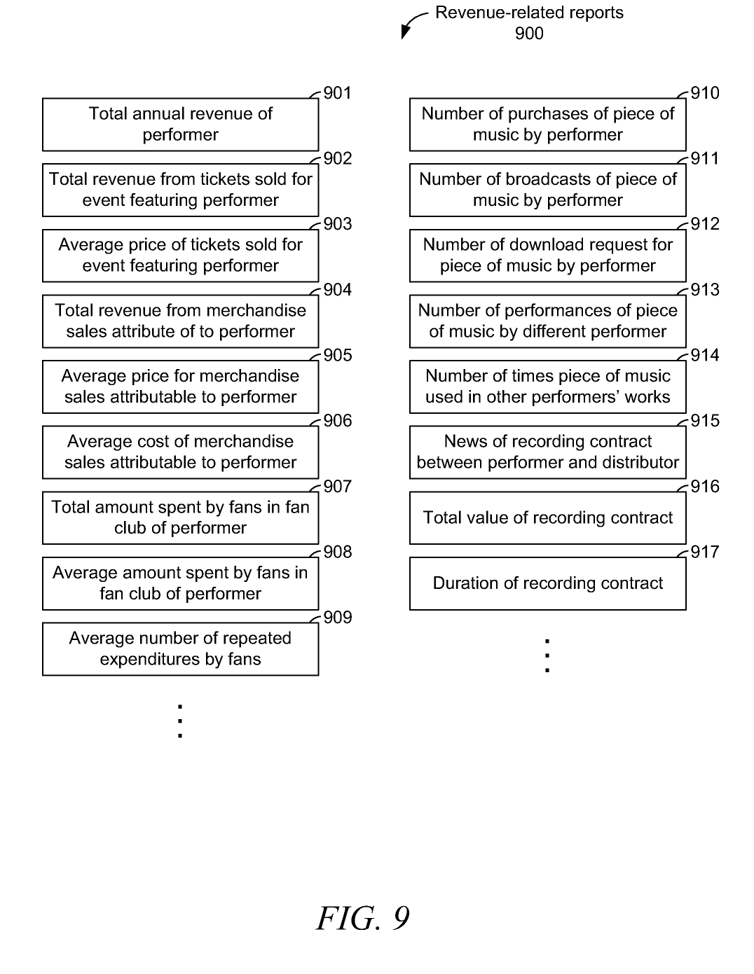

FIG. 9 is a conceptual diagram illustrating examples of revenue-related reports 900 pertinent to the performer 120, according to some example embodiments. A report 901 indicates a total of annual revenue of the performer 120. A report 902 indicates a total of revenue arising from tickets sold for the particular event that features the performer 120. A report 903 indicates an average price of tickets sold for the particular event that features the performer 120. A report 905 indicates an average price for merchandise sales (e.g., annual sales or sales at a particular event) that are at least partially attributable to the performer 120. A report 906 indicates an average cost of merchandise sales (e.g., annual sales or sales at a particular event) that are at least partially attributable to the performer 120. A report 907 indicates a total amount of money spent by fans of the performer 120 in a fan club of the performer 120. A report 908 indicates an average amount of money spent by the fans in the fan club. A report 909 indicates an average number of repeated expenditures by the fans in a fan club.

A report 910 indicates a number of purchases of a piece of music by the performer 120 (e.g., on CD or via digital download). A report 911 indicates a number of broadcasts of the piece of music by the performer 120 (e.g., from a radio station or an online music service). A report 912 indicates a number of download requests for the piece of music by the performer 120 (e.g., requests to download a song). A report 913 indicates a number of performances of the piece of music, where the performances are made by a different performer than the performer 120 (e.g., a number of “covers” of a song). A report 914 indicates a number of times the piece of music by the performer 120 was used in works by other performers (e.g., sampling a song for use in another song or video). A report 915 indicates news of a recording contract between the performer 120 and a distributing entity (e.g., a record company). A report 916 indicates a total value of the recording contract. A report 970 indicates the duration of the recording contract (e.g., expressed as a number of years).

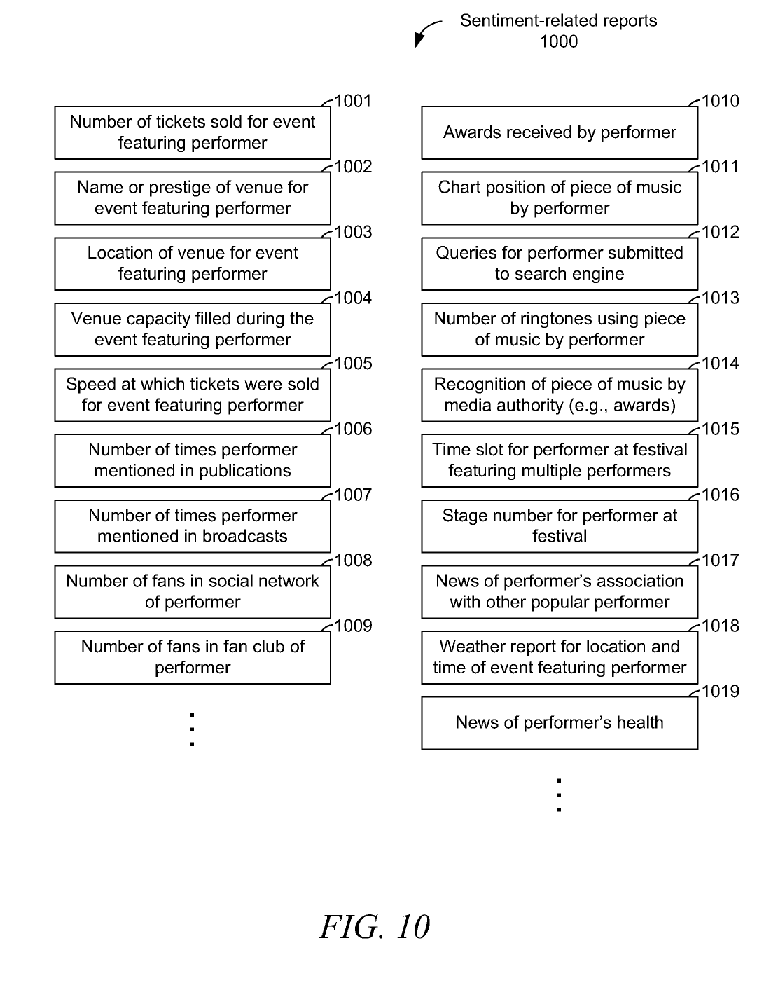

FIG. 10 is a conceptual diagram illustrating examples of sentiment-related reports 1000 pertinent to the performer 120, according to some example embodiments. A report 1001 indicates a number of tickets sold for an event that features the performer 120. A report 1002 indicates a name of a venue for the event that features the performer 120. In some example embodiments, the report 1002 indicates the prestige of the venue (e.g., an indicator of a degree of prestige for the venue). A report 1003 indicates a location of the venue for the event that features the performer 120. In some example embodiments, the report 1003 indicates the size of the venue (e.g., expressed as a seating capacity). A report 1004 indicates an extent that a capacity of the venue is filled during the event that features the performer 120 (e.g., expressed as a number of seats or as a percentage of total capacity). A report 1005 indicates a speed at which tickets were sold for the event that features the performer 120 (e.g., expressed as a table or graph of ticket sales over time). A report 1006 indicates a number of times that the performer 120 is mentioned in one or more publications (e.g., magazines, newspapers, or websites). A report 1007 indicates a number of times the performer 120 is mentioned in one or more broadcasts (e.g., radio, television, or web). A report 1008 indicates a number of fans in a social network of the performer 120 (e.g., members, friends, connections, or followers). A report 1009 indicates a number of fans in a fan club of the performer 120.

A report 1010 indicates a number of awards received by the performer 120 (e.g., with names or types of the received awards). A report 1011 indicates the chart position of the piece of music by the performer 120 (e.g., within a top 100 list of songs). A report 1012 indicates a number of queries for the performer 120 that were submitted to one or more search engines (e.g., a number of queries that reference the performer 120). A report 1013 indicates a number of ringtones that include at least some of the piece of music by the performer 120. A report 1014 indicates the use that the piece of music is recognized by one or more media authorities (e.g., rankings, honors, or awards). A report 1015 indicates a time slot for the performer 120 (e.g., used by the performer 120) at a festival that features multiple performers. A report 1016 indicates a stage number for the performer 120 (e.g., used by the performer 120) at the festival. A report 1017 indicates news that the performer 120 is associated with (e.g., is friends with or is married to) another popular performer (e.g., a celebrity performer). A report 1018 indicates a weather report for the location and the time of an event that features the performer 120 (e.g., news indicating that the event was canceled or poorly attended due to weather). A report 1019 indicates news regarding the health of the performer (e.g., a physical or mental condition of at least one member of the performer).

According to various example embodiments, one or more of the methodologies described herein may facilitate a funding of an event that features the performer 120. Accordingly, one or more of the methodologies described herein may benefit the performer 120 by making the advance payment available to reserve a venue for the event. Moreover, one or more of the methodologies described herein may benefit the consumers 110 by facilitating the arrangement and management of the event that features the performer 120. Furthermore, one or more the methodologies described herein may benefit the venue, the authorizing entity, or both, by tracking or administering one or more fees for services provided in facilitating the event.

FIG. 11 illustrates components of a machine 1100, according to some example embodiments, that is able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system and within which instructions 1124 (e.g., software) for causing the machine 1100 to perform any one or more of the methodologies discussed herein may be executed. In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a peer-to-peer (or distributed) network environment. The machine 1100 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1124 (sequentially or otherwise) that specify actions to be taken by that machine. Further, while only a single machine is illustrated, the term “machine” shall also be taken to include a collection of machines that individually or jointly execute the instructions 1124 to perform any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The machine 1100 may further include a graphics display 1110 (e.g., a plasma display panel (PDP), a liquid crystal display (LCD), a projector, or a cathode ray tube (CRT)). The machine 1100 may also include an alphanumeric input device 1112 (e.g., a keyboard), a cursor control device 1114 (e.g., a mouse, a touchpad, a trackball, a joystick, a motion sensor, or other pointing instrument), a storage unit 1116, a signal generation device 1118 (e.g., a speaker), and a network interface device 1120.

The storage unit 1116 includes a machine-readable medium 1122 on which is stored the instructions 1124 (e.g., software) embodying any one or more of the methodologies or functions described herein. The instructions 1124 may also reside, completely or at least partially, within the main memory 1104, within the processor 1102 (e.g., within the processor's cache memory), or both, during execution thereof by the machine 1100. Accordingly, the main memory 1104 and the processor 1102 may be considered as machine-readable media. The instructions 1124 may be transmitted or received over a network 1126 (e.g., network 490) via the network interface device 1120.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store instructions (e.g., instructions 1124). The term “machine-readable medium” shall also be taken to include any medium that is capable of storing instructions (e.g., software) for execution by the machine, such that the instructions, when executed by one or more processors of the machine (e.g., processor 1102), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

1. A method comprising:
accessing an aggregate of reports pertinent to a performer of entertainment, the aggregate of reports being accessed from a database;
determining a first amount of money that the performer is able to earn, the determining of the first amount being based on at least some of the aggregate of reports accessed from the database;
determining a likelihood that the performer will earn the first amount of money, the determining of the likelihood being performed by a processor of a machine and based on at least some of the aggregate of reports accessed from the database; and
authorizing a second amount of money as an advance payment corresponding to the performer, the authorizing of the second amount being based on the first amount and the likelihood.

2. The method of claim 1 further comprising:
accessing a plurality of revenue-related reports within the aggregate of reports accessed from the database, the plurality of revenue-related reports being descriptive of transactions attributable at least in part to the performer; and wherein
the determining of the first amount of money is based on the plurality of revenue-related reports.

3. The method of claim 2 further comprising:
initiating a network crawling operation configured to access multiple server machines and store at least some of the plurality of revenue-related reports in the database.

4. The method of claim 2, wherein the plurality of revenue-related reports includes at least one of:
a total annual revenue of the performer,
a total revenue from tickets sold for an event featuring the performer,
an average price for tickets sold for the event featuring the performer,
a total revenue from merchandise sales attributable to the performer,
an average price for merchandise sales attributable to the performer,
an average cost of merchandise sales attributable to the performer,
a total expenditure of money by fans in a fan club of the performer,
an average expenditure of money by the fans of the performer,
an average number of repeated expenditures of money by the fans,
a number of purchases of a piece of music by the performer,
a number of times the piece of music has been broadcast,
a number of times the piece of music has been requested for download,
a number of performances of the piece of music by a different performer,
a number of different pieces of music that include at least some of the piece of music,
an indication of an agreement between the performer and a media distribution entity,
a total monetary value of the agreement, or
a duration of the agreement.

5. The method of claim 1 further comprising:
accessing a plurality of sentiment-related reports within the aggregate of reports accessed from the database, the plurality of sentiment-related reports being descriptive of a popularity of the performer; and wherein
the determining of the likelihood is based on the plurality of sentiment-related reports.

6. The method of claim 5 further comprising:
initiating a network crawling operation configured to access multiple server machines and store at least some of the plurality of sentiment-related reports in the database.

7. The method of claim 5 further comprising:
receiving activity data from a device configured to interact with a fan of the performer, the activity data indicating a level of interest in the performer expressed by the fan in interacting with the device; and
generating at least one of the plurality of sentiment-related reports from the activity data.

8. The method of claim 5, wherein the plurality of sentiment-related reports descriptive of the popularity of the performer includes at least one of:
a number of tickets sold for an event featuring the performer,
a name of a venue for the event featuring the performer,
a location of the venue for the event featuring the performer,
an extent that a capacity of the venue was filled during the event,
a speed at which tickets were sold for the event featuring the performer,
a number of mentions of the performer in one or more publications,
a number of mentions of the performer in one or more broadcasts,
a number of fans of the performer within a social network,
a number of fans of the performer in a fan club of the performer,
an indication that the performer received an award,
a chart position indicating a degree of popularity of a piece of music by the performer,
a number of queries for the performer submitted to a search engine,
a number of queries for the piece of music submitted to the search engine,
a number of ringtones including at least some of the piece of music,
an indication that the piece of music was recognized by a media authority,
a time slot for the performer at a further event featuring multiple performers,
a stage number for the performer at the event featuring multiple performers,
an indication that the performer is associated with a further performer having a further likelihood of earning a further amount of money, the further likelihood transgressing a threshold likelihood,
a weather report for the event featuring the performer, or
news regarding health of the performer.

9. The method of claim 5 further comprising:
the determining of the likelihood includes generating a score indicative of a risk that the performer will fail to earn the first amount of money, the generating of the score being based on the plurality of sentiment-related reports; and wherein
the determining of the likelihood is based on the score.

10. The method of claim 9 further comprising:
the generating of the score includes applying one of a plurality of weights to each of the plurality of sentiment-related reports.

11. The method of claim 10 further comprising:
accessing the plurality of weights from the database, the database storing a human-generated data structure containing at least one of the plurality of weights.

12. The method of claim 1 further comprising:
communicating the second amount of money to a financial entity configured to provide the second amount of money as the advance payment for the performer.

13. The method of claim 12 further comprising:
determining a time period from a date for the communicating of the second amount of money until a further date of an expected repayment of at least some of the advance payment; and wherein
the authorizing of the second amount of money is based on the time period.

14. The method of claim 1 further comprising:
determining a risk trend based on the likelihood of the performer and based on a further likelihood of the performer, the likelihood and the further likelihood being determined at different times; and
the authorizing of the second amount of money is based on the risk trend.

15. The method of claim 1 further comprising:
receiving a repayment report that indicates a reception of at least some of the second amount of money in repayment of the advance payment.

16. The method of claim 15 further comprising:
determining a third amount of money to be paid to the performer, the determining of the third amount of money being based on the at least some of the second amount of money received in repayment of the advance payment.

17. The method of claim 16 further comprising:
initiating a transfer of the third amount of money to the performer.

18. The method of claim 16, wherein:
the determining of the third amount of money is based on a service fee charged for the authorizing of the second amount of money.

19. The method of claim 18 further comprising:
determining the service fee based on at least one of:
the first amount of money,
a score indicative of a risk that the performer will fail to earn the first amount of money, or
a time period from a communication of the second amount of money until the repayment of the advance payment.

20. The method of claim 1, wherein:
the performer of entertainment includes at least one of a soloist, an ensemble, a musician, a vocalist, a dancer, an actor, an athlete, a poet, a minister, a celebrity, a lecturer, a speaker, a coach, a teacher, a politician, a comedian, a juggler, a magician, an acrobat, a daredevil, an animal, or a clown.

21. A system comprising:
means for accessing an aggregate of reports pertinent to a performer of entertainment, the aggregate of reports being accessed from a database;
a revenue module configured to determine a first amount of money that the performer is able to earn, the determining of the first amount being based on at least some of the aggregate of reports accessed from the database;
a risk module implemented by a processor of a machine, the risk module being configured to determine a likelihood that the performer will earn the first amount of money, the risk module being configured to determine the likelihood based on at least some of the aggregate of reports accessed from the database; and
an authorization module configured to authorize a second amount of money as an advance payment corresponding to the performer, the authorizing of the second amount being based on the first amount and the likelihood.

22. A non-transitory machine-readable storage medium comprising instructions that, when executed by one or more processors of a machine, cause the machine to perform operations comprising:
accessing an aggregate of reports pertinent to a performer of entertainment, the aggregate of reports being accessed from a database;
determining a first amount of money that the performer is able to earn, the determining of the first amount being based on at least some of the aggregate of reports accessed from the database;
determining a likelihood that the performer will earn the first amount of money, the determining of the likelihood being based on at least some of the aggregate of reports accessed from the database; and
authorizing a second amount of money as an advance payment corresponding to the performer, the authorizing of the second amount being based on the first amount and the likelihood.
